(19) United States
(12) Patent Application Publication
(10) Pub. No.: US 2012/0279123 A1
(43) Pub. Date: Nov. 8, 2012

(54) DECORATIVE CONTAINER

(75) Inventor: Ravi Rajagopalan, Philadelphia, PA (US)

(73) Assignee: Pride Garden Products, King of Prussia, PA (US)

(21) Appl. No.: 13/101,226

(22) Filed: May 5, 2011

(51) Int. Cl. A01G 9/02; B65D 1/40

(52) U.S. Cl. 47/65.7; 220/675

(57) ABSTRACT

An injection molded container such as a flower pot having an outer surface and an inner surface and an indentation of a shape and size corresponding to the shape and size of a design element member, the design element member and the container member adapted to easily engage one another and to be easily disengaged so as to provide at least one decorative element on the outside surface of the container which can be easily changed according to a selectable design scheme.

### BACKGROUND OF THE INVENTION

This invention relates to the field of containers and more particularly to containers having a decorative feature on the outer surface thereof.

Decorative flower pots and other types of containers are well known. For example, Guloy, U.S. Pat. Publ. 2005/0146073 describes such a flower pot wherein decorative flower pot having an outer peripheral surface with embossed decorations, formed by using a female mold cavity having walls and contours which have a desired embossed design. Other earlier flower pots are cited in U.S. Pat. Publ. 2005/0146073 including flower pots having a wrapping adhered thereto, having a sheet of material with printed and embossed patterns disposed thereon, and other cover type decorative elements and members.

U.S. Pat. No. 6,702,919, to Weder, disclosed a method of forming a preformed flower pot having a cloth-like appearance suitable for use in the formation of flower pot covers, floral wrappings and ribbon materials. U.S. Pat. No. 6,645,408 to Weder disclosed methods for producing preformed, shape-sustaining flower pot covers and methods of wrapping floral groupings and flower pots with a sheet of polymeric material having a texture or appearance simulating the texture or appearance of paper to provide a decorative cover for such floral groupings and flower pots. Weder, et al., U.S. Pat. No. 6,295,791 disclosed a decorative cover for a flower pot using a collar. Weder U.S. Pat. No. 5,105,599 disclosed a means for securing a decorative cover about a flower pot.

GB pat. Appl. 2,273,029 to Tanner disclosed a flower pot having an interchangeable decorative tray ring which is screwed to the drain tray. U.S. Pat. No. 1,446,563 to Hughes disclosed a decorative covering for flower pots, bouquets, and the like.

In certain circumstances people wish to change the appearance of a flower pot or other type container to match a particular décor, color scheme, or mood. With current and earlier types of flower pots and other containers, it is difficult to change the appearance and, even when the appearance is changed, it is at times difficult to obtain a clean and neat design appearance.

It is an object of the present invention to provide a container which has an easily changeable appearance and when changed to have a clean and neat design appearance.

### SUMMARY OF THE INVENTION

The present invention addresses these needs in the art and comprises in one aspect an injection molded container which has one or more indented areas in its outside surface adapted to receive a design element having an outside surface of a different color and/or texture from the injection molded pot. The indented area or areas are formed when the container is molded and are of the same material as the rest of the container.

In some embodiments an indented area comprises female holes which receive prongs on the reverse side of the design element. In other embodiments the design element is press fitted into the indented area. The design element can be any of a wide variety of shapes, colors, sizes, and surface textures. Examples of design elements include bands which fit around the circumference of a container in an indent which encircles the circumference, a button, a square, diamond, triangle, star, or any other desired shape which corresponds to the indented area of the container which, in turn, has the same shape as the design element.

There can be any number of design elements. In the case of bands which encircle the circumference, usually there are no more than three bands and corresponding indented areas, but in some cases, especially with larger containers, there can be more than three. For disk shaped design elements, in some embodiments there is one corresponding indented area while in other embodiments there can be two or more such indented areas. For design elements of other shapes, any number of design elements and corresponding indented areas can be used. In some embodiments design elements of a plurality of shapes, sizes, colors, and surface textures can be used in one pot. In some embodiments the outer surface of one or more design elements can include indicia such as a company logo, a sports team insignia, initials of a person, by way of example. The design elements may, in some embodiments, include a reflective surface such as a mirror or an electronic element such as an LED or LCD so as to cause the design element to light up or flash. The design elements can be molded, for example by injection molding, or they can be formed by other methods, especially when they are made of materials other than plastic such as jute, rope, raffia, or metals.

The container and design elements can be provided as a kit wherein various colors and/or textures of a particularly shaped design element are provided along with one or more containers having different colors and/or textures from each other and from the design elements.

The method of injection molding the container is conventional, although the inclusion of indented areas is novel.

In many embodiments of the invention, the container is in the form of, and useful as, a flower pot.

In many embodiments the surface of the decorative element is flush or nearly flush with the surface of the container so that the appearance is smooth and flat. In these embodiments the depth of the indentation is the same or very close to the thickness of the decorative element.

### BRIEF DESCRIPTION OF THE DRAWINGS

FIG. 1 is a side perspective view of a flower pot container having a circular design element engaged in a corresponding indentation.

FIG. 2 is a side perspective view of the flower pot container of FIG. 1 with the design element removed.

FIG. 3 is another perspective view of the flower pot container of FIG. 2.

FIG. 4 is a front perspective view of the flower pot container of FIG. 1.

FIG. 5 is a cross-sectional view of through V-V of FIG. 4.

FIG. 6 is a schematic view of a kit according to the invention comprising a plurality of design elements and a flower pot container having an indentation which corresponds to each of the design elements.

FIG. 7 is a perspective view of a flower pot container having a band-shaped design element.

FIG. 8 is a perspective view of the flower pot container of FIG. 7 with the band removed.

FIG. 9 is a top view of a flower pot container of FIG. 8.

FIG. 10 is a bottom view of a flower pot container embodiment of FIG. 8 illustrating holes in the bottom of the pot.

FIG. 11 is a third embodiment of a flower pot container wherein the indentation and the corresponding design element are rectangular wherein the design element is shown as removed.

FIG. 12 is a side view of the flower pot container of FIG. 11.

FIG. 13A is a side perspective view of a flower pot container with decorative element separated.

FIG. 13B is a side perspective view of a flower pot container with a second embodiment of a decorative element separated.

Similar reference characters denote corresponding features consistently throughout the attached drawings.

FIG. 14 is a perspective view of an alternative embodiment of a decorative element.

FIG. 15 is a perspective view of a two-piece decorative element.

FIG. 16 is a perspective view of an alternative two-piece decorative element.

### DETAILED DESCRIPTION

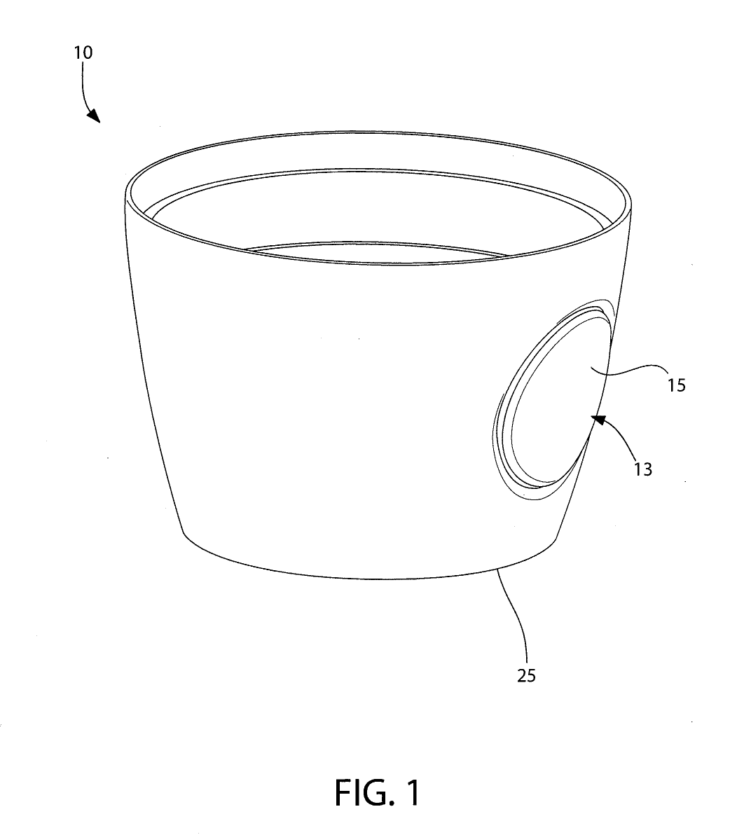

Referring now to FIG. 1, flower pot container 10 is illustrated with round button 13 having outside decorative surface 15. The pot 10 has a bottom 25.

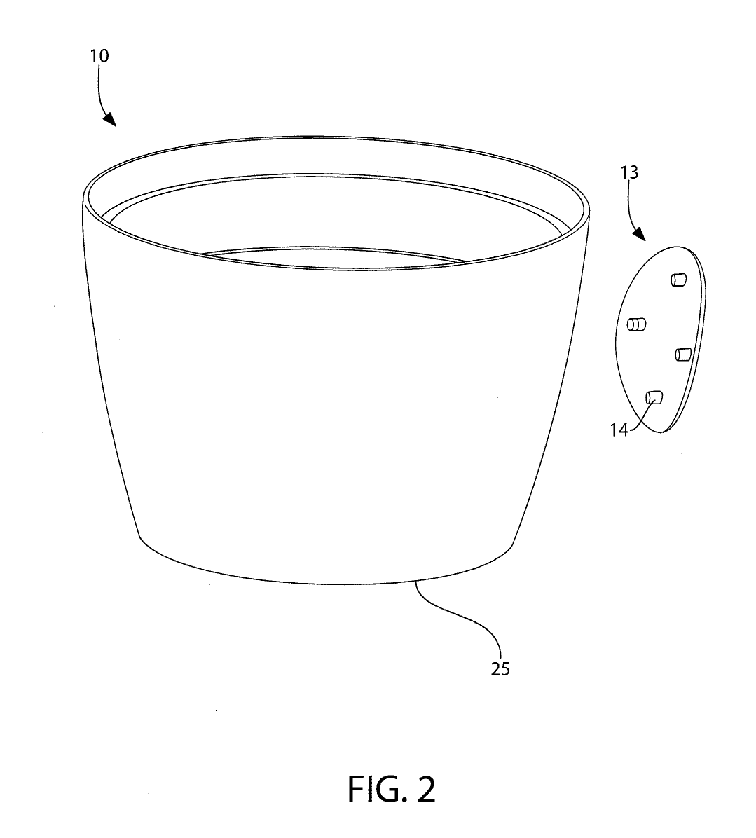

FIG. 2 illustrates the button decorative element 13 removed from pot 10, having prongs 14 on the reverse side which is not exposed when the decorative element is engaged in the indented portion. The reverse side of the design element will be adjacent to the indented portion of the flower pot container.

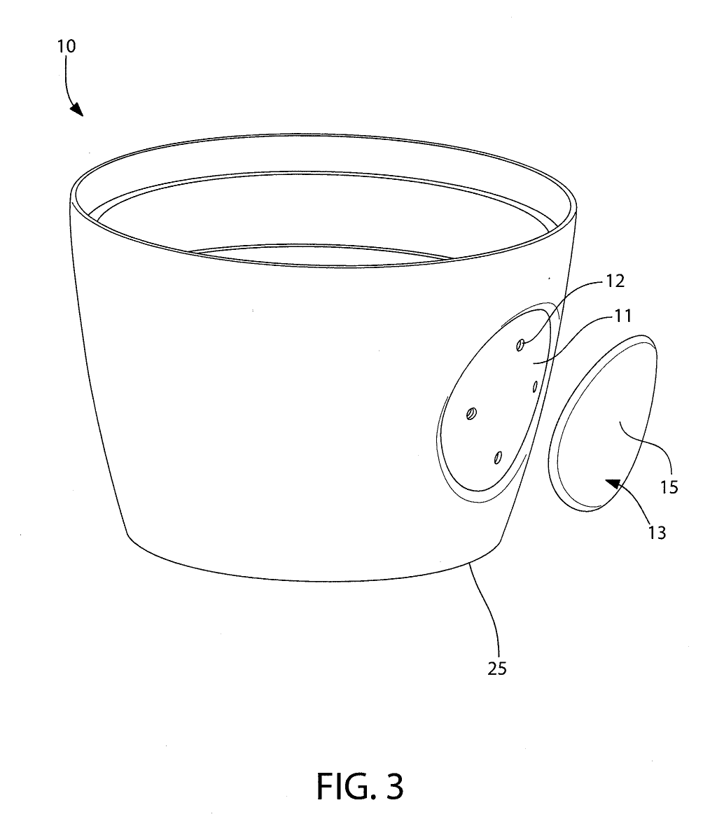

FIG. 3 illustrates the flower pot container of FIG. 1 with the round indented portion 11 having holes 12 which correspond to the prongs 14 shown in FIG. 2. The decorative element can be pressed onto the outside of the flower pot container 10 indented area 11 so that the prongs 14 fit and engage with holes 12 and the decorative surface 15 of button 13 is exposed on the outside of pot 10, forming a decorative feature of a flower pot container. In other embodiments the design element can be pressed into the indented area and is retained without the use of prongs and holes.

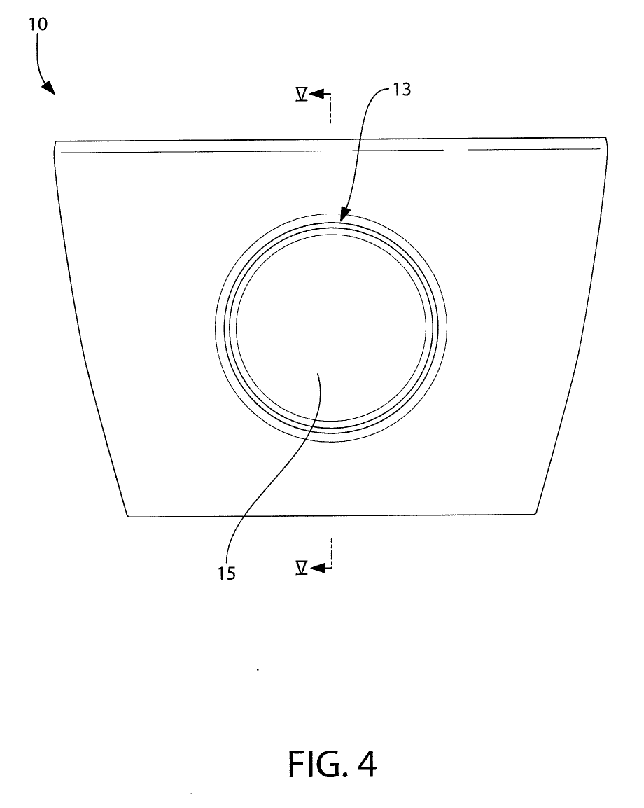

FIG. 4 is a front view of the pot 10 with the button shaped decorative element 13 facing forward so that decorative surface 15 is visible.

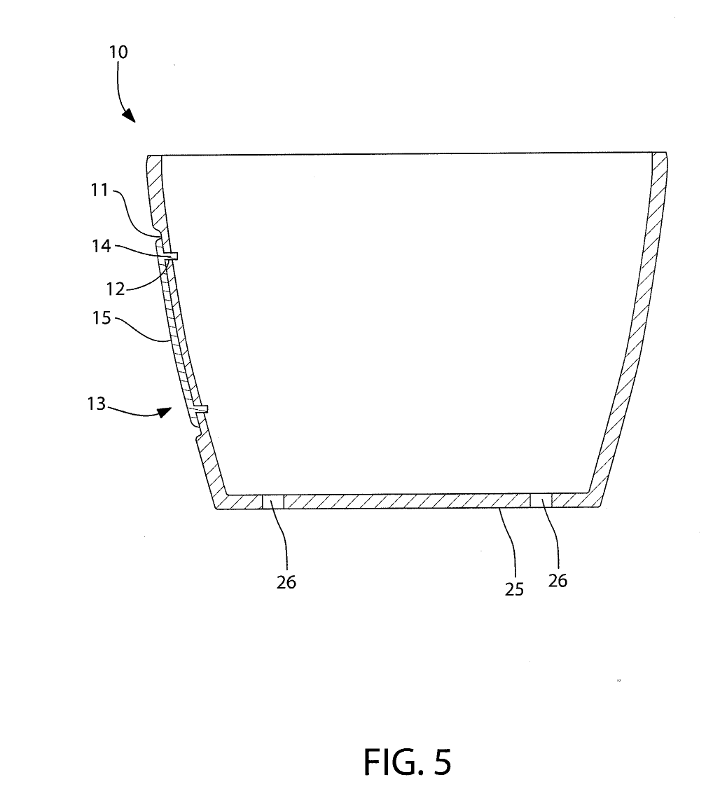

FIG. 5 is a cross-sectional view of the pot 10 of FIG. 4 illustrating decorative element 13 having decorative surface 15 and prongs 14 which fit within holes 12 in pot to retain the decorative element 13 in indented area 11. The bottom 25 has holes 26.

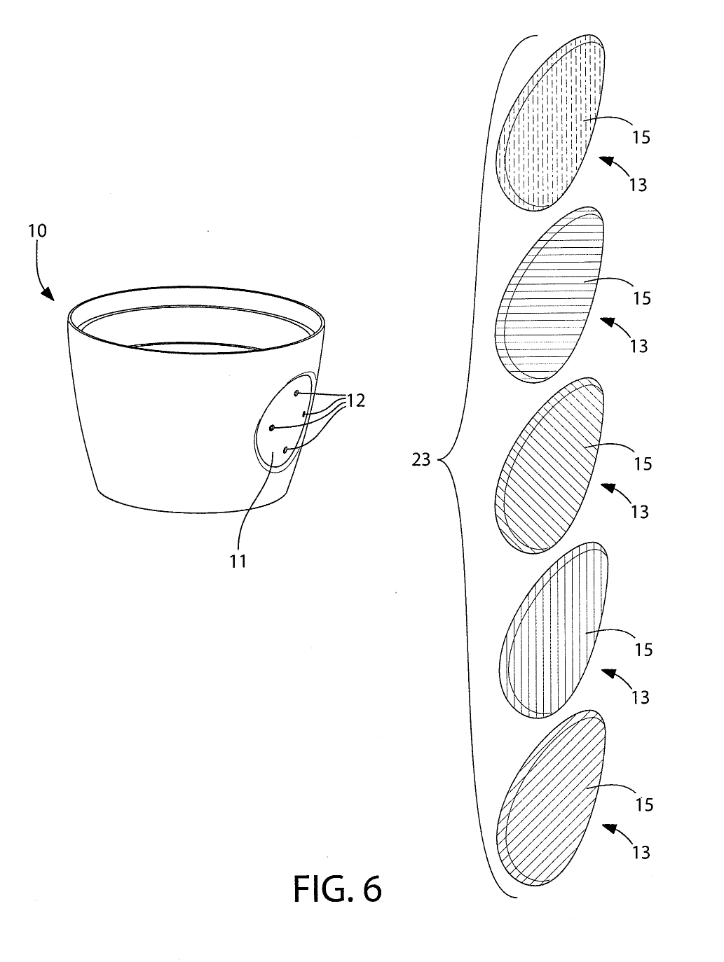

FIG. 6 is a schematic view of a kit according to the invention comprising a plurality of design elements 13 and a flower pot container 10 having an indentation 11 with holes 12 which corresponds to each of the design elements 13. Each of the design elements 13 is of a different color or surface texture 15 and are easily interchangeable to suit the design requirements of the user. In some alternative embodiments a removable or non-removable decorative sticker can be applied to the surface 15 of a design element 13.

FIG. 7 is a perspective view of an alternative embodiment flower pot container 10A having a band-shaped indentation 18 around the central circumference and a rim indentation 18A around the top circumference.

Design elements in the form of band 19 fit within the indentation 18. Band 19 can be of any color or texture and in some embodiments can include a decorative sticker, which can be a removable or permanent decorative sticker, on its outer surface.

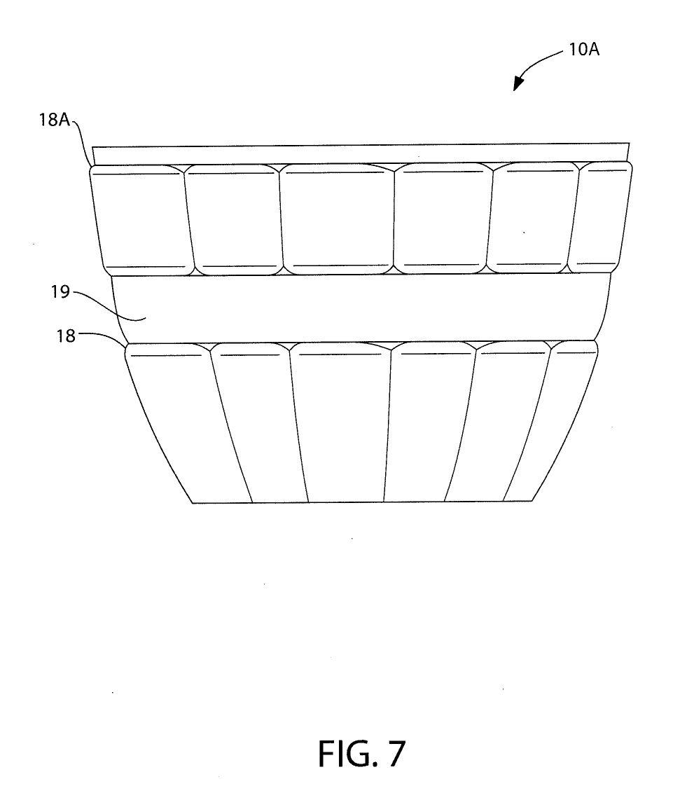

FIG. 8 is a perspective view of the a flower pot container 10A with the band 19 separated from indented area 18. This embodiment includes a lip 21 which does not receive a band.

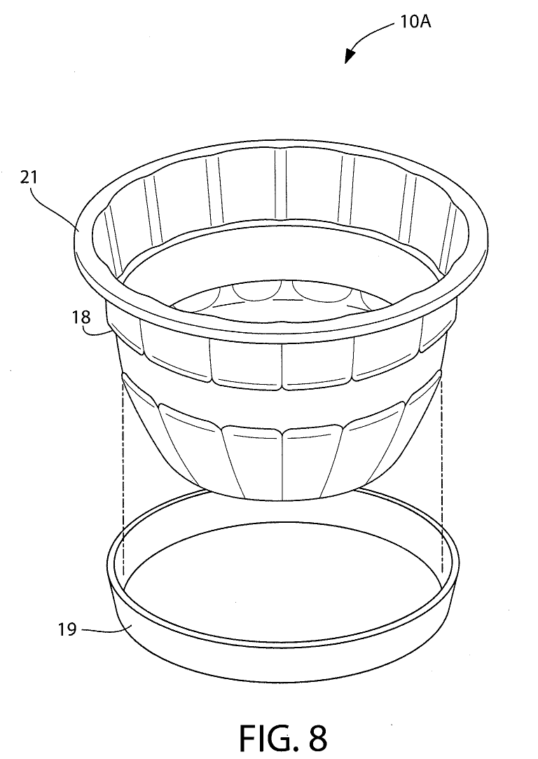

FIG. 9 is a top view of a flower pot container of FIG. 8.

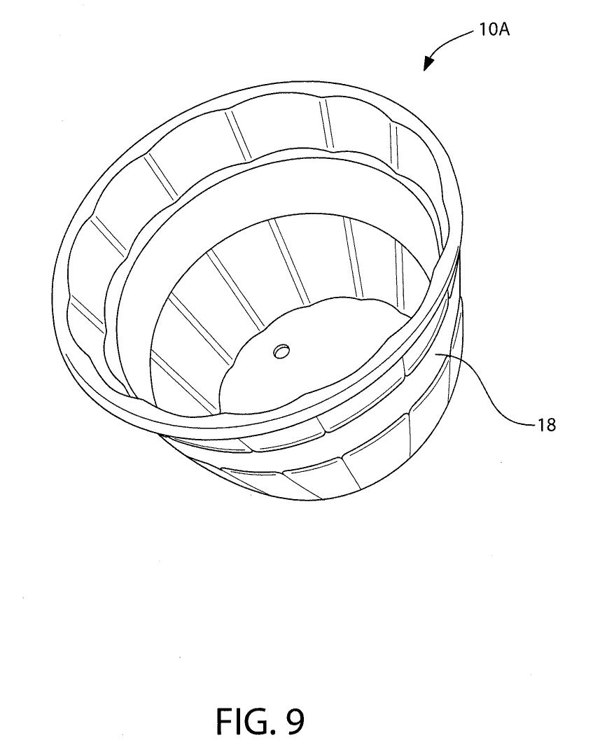

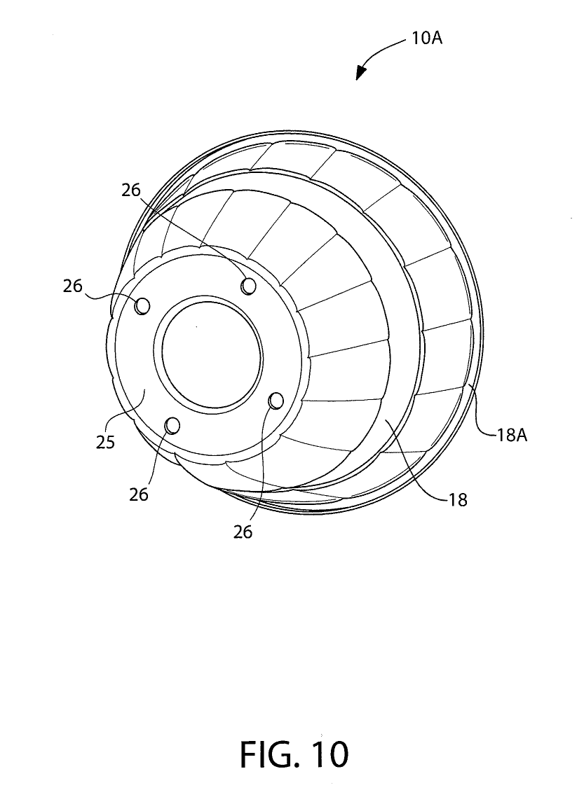

FIG. 10 is a bottom view of a flower pot container 10A illustrating holes in the bottom 25 of the pot, indented area 18 around the central circumference, and indented area 18A around the upper circumference.

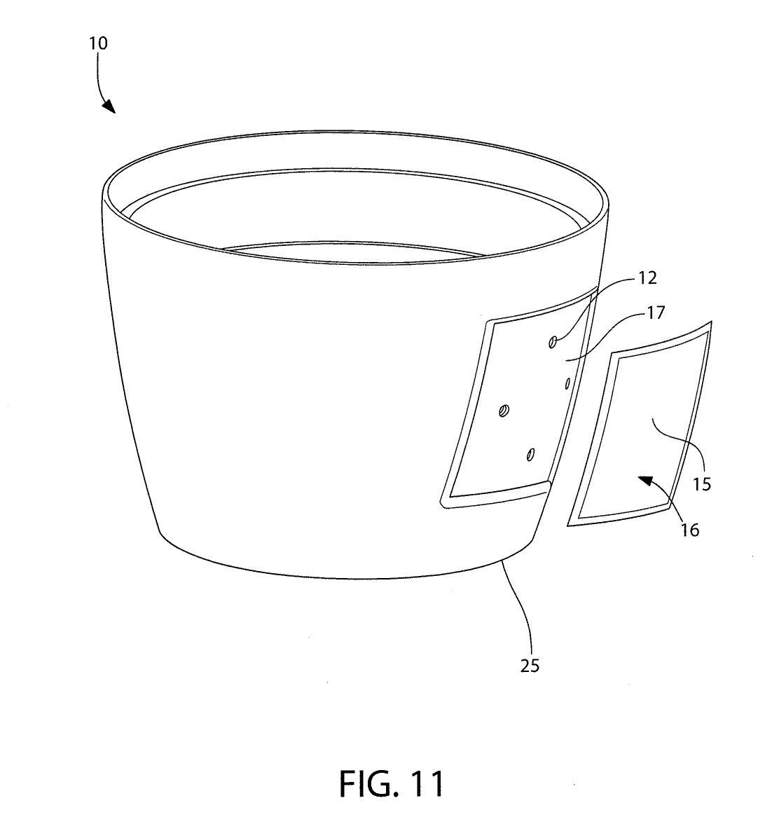

FIG. 11 is a third embodiment of a flower pot container wherein the indentation 17 having holes 12 and the corresponding design element 16 are rectangular.

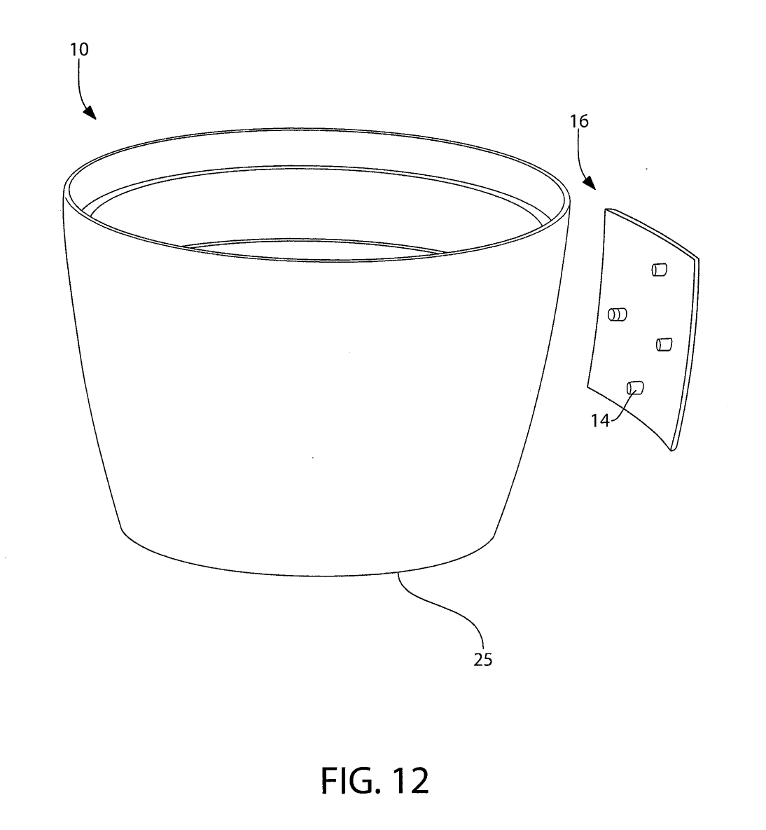

FIG. 12 is a side view of the flower pot container 10 of FIG. 11 showing design element 16 having prongs 14.

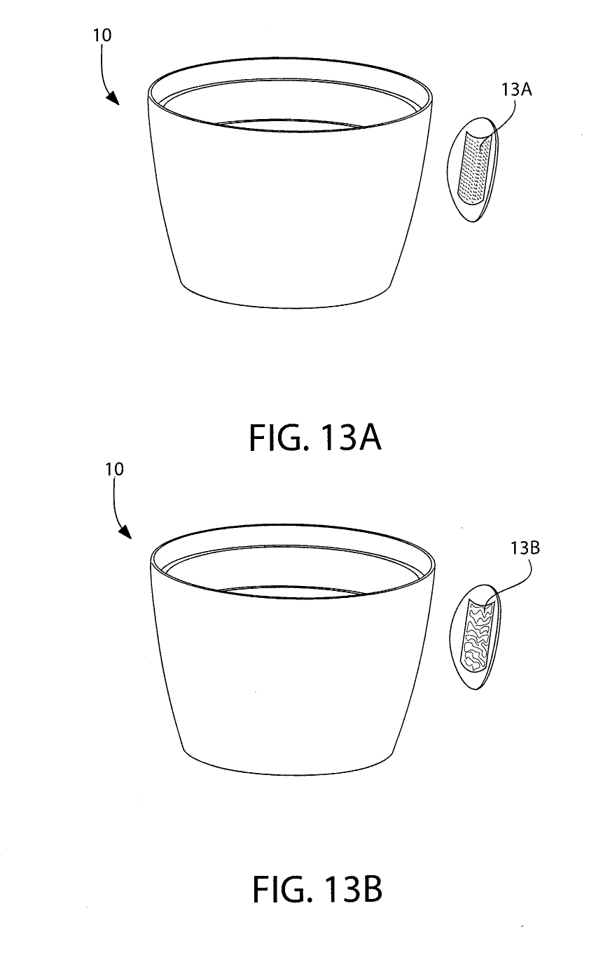

FIG. 13A shows flower pot container 10 with a design element 13A having loop and eye material such as “Velcro” on the side facing the pot.

FIG. 13B is similar to FIG. 13A except the design element 13B has adhesive on the side facing the pot. In this embodiment the adhesive is not permanent such as would be the case with epoxy, but rather is semi-permanent in that the decorative element can be removed and replaced with another decorative element.

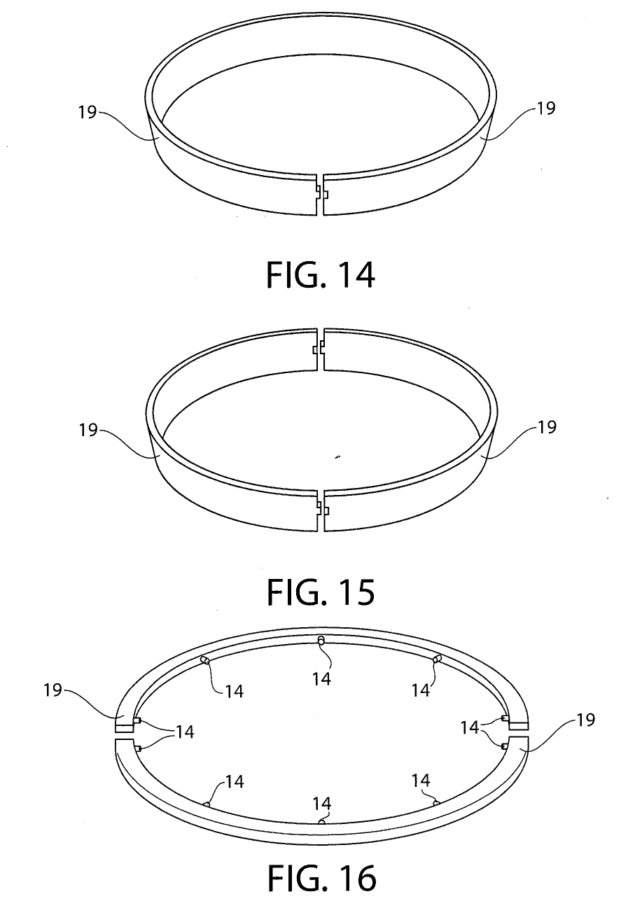

FIG. 14 is a perspective view of an alternative embodiment of a decorative element 19 in the form of a flat band 19 which has a male mating element at one end and a female mating element at the other end so that the element 19 can be wrapped around band 18 (FIG. 10) and locked in place. The flat band embodiments of band 19 can be of any suitable material which can be bent and retains its shape, examples of which include tin and aluminum.

FIG. 15 is a perspective view of a two-piece decorative element 19 with ends with mating ends so that the two pieces can be locked to each other and form a continuous band around indentation 18 (FIG. 10).

FIG. 16 is a perspective view of an alternative two-piece decorative element wherein projections which correspond to holes in indentation 18 (FIG. 10) are included as the elements which cause the element 19 to be removably engaged to container 10,

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

1. An article comprising a design element member and an injection molded container member having an outer surface and an inner surface and an indentation of a shape and size corresponding to the shape and size of a design element member, the design element member and the container member adapted to easily engage one another and to be easily disengaged so as to provide at least one interchangeable decorative element on the outside surface of the container.

2. The article of claim 1 wherein an indentation and a corresponding design element member have a shape selected from circle, square, rectangle, diamond, trapezoid, star, and oval.

3. The article of claim 1 wherein the design element member has at least one prong and the corresponding indented area of the container member has at least one hole which is adapted to receive and engage the at least one prong so that the outside surface of the decorative element is visible when viewing the outer surface of the container.

4. The article of claim 1 wherein the design element member has at least one hole and the corresponding indented area of the container member has at least one prong.

5. The article of claim 1 wherein the design element is constructed of plastic, fabric, metal, glass, stone, or paper.

6. The article of claim 1 wherein the design element member and indented area of the container have corresponding hook and eye plastic material adapted to engage and thereby retain the design element in the indented area of the container.

7. The article of claim 1 wherein at the container member includes an indentation around the surface and at least one design element member has a belt shape adapted to fittingly engage the indentation around the surface, and wherein the indentation has a depth and the decorative element has an edge and said edge has a thickness, wherein the depth is the same as the thickness so that, when engaged in the indentation of the container, the edge is flush with the container.

8. The article of claim 1 wherein the container member includes an indentation around the surface and at least one design element member has a belt shape adapted to fittingly engage the indentation around the surface and wherein the belt is either (A) a continuous loop; (B) an open strip with interlocking ends; (C) a two piece member wherein each piece includes interlocking ends; or (D) a two piece member with inwardly facing prongs which are located to engage corresponding holes in an indented area of the outside of the container, and wherein the indentation has a depth and the decorative element has an edge and said edge has a thickness, wherein the depth is the same as the thickness so that, when engaged in the indentation of the container, the edge is flush with the container.

9. The article of claim 1 wherein the indentation has or the indentations have a depth and the decorative elements have an edge and said edges have a thickness, wherein the depth is the same as the thickness so that, when engaged in the indentation of the container, the edge appears flush with the container.

10. The article of claim 1 wherein the container is in the form of, functions as, and is adapted for use as, a flower pot.

11. A kit comprising an injection molded container member and a plurality of design element members of a plurality of colors and/or textures, each design element member having the same shape, the container having an outer surface and an inner surface and at least one indentation of a shape and size corresponding to the shape and size of the design element members, the design element members and the container member adapted to easily engage one another and to be easily disengaged so as to provide at least one decorative element on the outside surface of the container.

12. A method for changing decorative elements on a pot comprising:
a. inserting a first decorative element, having a shape and size, into an indentation in a pot having the same shape and size as a said decorative element;
b. removing said decorative element and inserting a second decorative element, having a shape and size, into said indentation in said pot having the same shape and size as said second decorative element.
